(19) United States
(12) Patent Application Publication
(10) Pub. No.: US 2026/0219821 A1
(43) Pub. Date: Jul. 30, 2026

(54) PRINTING SYSTEM GENERATING A PLURALITY OF SETS OF LABEL DATA BASED ON DATABASE

(71) Applicant: BROTHER KOGYO KABUSHIKI KAISHA, Nagoya (JP)

(72) Inventor: Junjiro YOSHIDA, Nagoya (JP)

(21) Appl. No.: 19/406,506

(22) Filed: Dec. 2, 2025

(30) Foreign Application Priority Data
Jan. 24, 2025 (JP) 2025-010220

(51) Int. Cl. G06F 3/12

(52) U.S. Cl. CPC G06F 3/1256; G06F 3/1208; G06F 3/1243

(57) ABSTRACT

A controller of an information processing device displays an editing screen for receiving an operation to edit a reference label image. The controller selects a time-display object based on an operation and specifies a database defining rows and columns. In response to receiving a print instruction, the controller calculates a time-related value for each of target rows based on data in a selected column of that row. The time-related value indicates a date or a time of day. The controller generates a set of label data for each of the target rows. The set of label data represents a label image in which the selected time-display object is placed and the time-related value is inserted into the time-display object. The controller instructs a label printer to print the label image based on the set of label data for each of one or more of the target rows.

### REFERENCE TO RELATED APPLICATIONS

This application claims priority from Japanese Patent Application No. 2025-010220 filed on January 24, 2025. The entire content of the priority application is incorporated herein by reference.

### BACKGROUND ART

A known configuration used with label printer reads printing conditions from a database having a table format having rows and columns and prints labels with the label printer using the print conditions. Through such a configuration, the label printer can be controlled to batch print labels for a plurality of types of products. Another known configuration for printing expiration dates prints labels with a date set to a certain amount of time after the time of printing.

### SUMMARY

Known methods of performing label printing using a database are simple in nature and cannot print data that more appropriately reflects the user's preferences.

In view of the foregoing, it is an object of the present disclosure to provide a method which, by utilizing a database, enables fine-tuned label printing that meets the user's preferences.

In order to attain the above and other objects, the present disclosure provides a non-transitory computer-readable storage medium storing instructions for an information processing device. The instructions, when executed in the information processing device, causes the information processing device to perform: a display process including: displaying an editing screen on a display in the information processing device, the editing screen being for receiving an operation to edit a reference label image; an object selecting process including: selecting a time-display object based on an operation received through the editing screen; a specifying process including: specifying a database defining rows and columns; a column selecting process including: selecting a column of the columns; a calculating process in response to receiving a print instruction, the calculating process including: calculating a time-related value for each of target rows based on data in the selected column of the each of the target rows, the time-related value indicating a date or a time of day, the target rows being two or more of the rows; a generating process including: generating a set of label data for each of the target rows based on the reference label image, the set of label data for the each of the target rows representing a label image in which the selected time-display object is placed and the time-related value for the each of the target rows is inserted into the time-display object; and a printing process including: instructing a label printer to print the label image based on the set of label data for each of one or more of the target rows.

According to another aspects, the disclosure provides a printing system. The printing system includes an information processing device and a label printer. The information processing device includes a first controller including one or more first processors, and a display. The label printer includes a second controller including one or more second processors. The first controller is configured to perform: a display process including: displaying an editing screen on the display, the editing screen being for receiving an operation to edit a reference label image; an object selecting process including: selecting a time-display object based on an operation received through the editing screen; a specifying process including: specifying a database defining rows and columns; a column selecting process including: selecting a column of the columns; a template generating process including: generating template data, the template data including image data and column-identification data, the image data representing the reference label image in which the selected time-display object is placed, the column-identification data identifying the selected column; and a transferring process in response to receiving a transferring instruction, the transferring process including: transferring the template data and the database to the label printer. The second controller is configured to perform: a storing process including: storing the template data and the database both received from the information processing device in a storage; a calculating process in response to receiving a printer-side print instruction issued within the label printer, the calculating process including: reading both the template data and the database from the storage; identifying the selected column based on the column-identification data; calculating a time-related value for each of target rows based on data in the selected column of the each of target rows, the time-related value indicating a date or a time of day, the target rows being two or more of the rows; a generating process including: generating a set of label data for each of the target rows, the set of label data for the each of the target rows representing a label image in which the selected time-display object is placed and the time-related value for the each of the target rows is inserted into the time-display object; and a printing process including: printing the label image based on the set of label data for each of one or more of the target rows.

In the above structures, the label images can be printed such that different time-related values are placed on different label images, thereby improving usability and convenience of the label printer.

### BRIEF DESCRIPTION OF DRAWINGS

FIG. 1 is a schematic diagram illustrating a configuration of a printing system.

FIG. 2 is a sequence diagram illustrating a procedure of generating label data on a printing application side and perform printing based on the label data on a label printer side.

FIG. 3 is an illustration of an example of a database.

FIGS. 4-7 are illustrations of examples of a label editing screen.

FIG. 8 is a flowchart illustrating an example of a calculation process.

FIG. 9 is an illustration of an example of a method for specifying an addition time.

FIG. 10 is an illustration an example of a print settings screen.

FIG. 11A is a sequence diagram illustrating a procedure of generating label data and perform printing based on the label data both on the label printer side.

FIG. 11B is a diagram illustrating an example of a template to be transferred.

### DESCRIPTION

Below, an embodiment of the program according to the present disclosure will be described while referring to the accompanying drawings. The specification discloses a printing system having a program that can be executed on an information processing device, and a label printer that can communicate with the information processing device.

### Overall Configuration of a PC 1

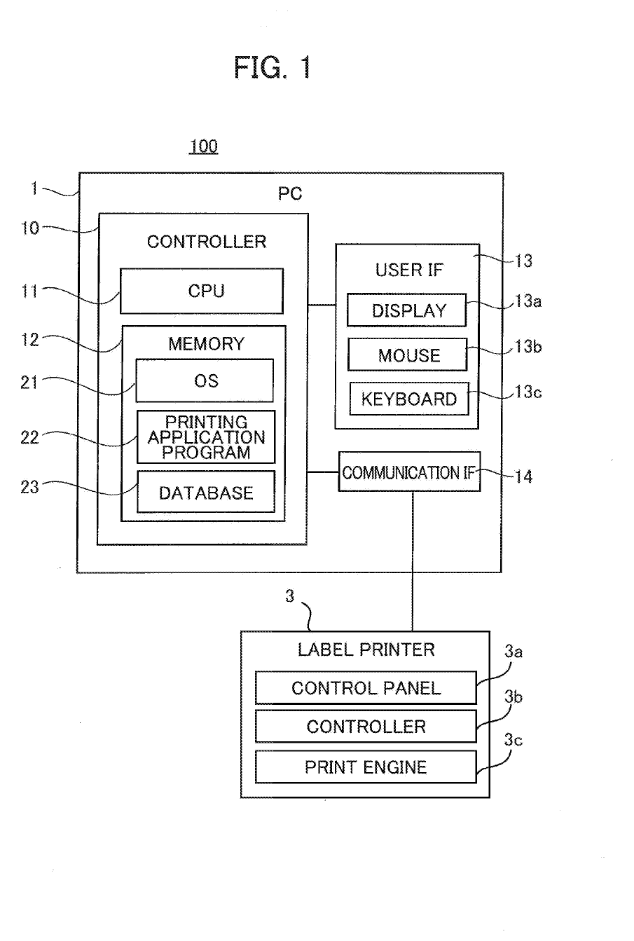

FIG. 1 shows a printing system 100 according to this embodiment. The printing system 100 has a personal computer (hereinafter “PC”) 1 and a label printer 3. The PC 1 and label printer 3 are connected and capable of communicating with each other. As shown in FIG. 1, the PC 1 includes a controller 10 that includes a CPU 11 and a memory 12. The PC 1 also includes a user interface (also referred to as a “user IF”) 13 and a communication interface (also referred to as a “communication IF”) 14 that are both electrically connected to the controller 10. The controller shown in FIG. 1 is a generic term that covers hardware and software used for controlling the PC 1 and is not limited to a piece of hardware present in the PC 1. The PC 1 is an example of the image processing device. However, the image forming device is not limited to the PC 1 and may be a smartphone or a tablet terminal.

The CPU 11 executes various processes according to programs read from the memory 12 or based on user operations. The memory 12 stores various programs including an operating system (hereinafter “OS”) 21, and a printing application program (hereinafter “printing app”) 22; and various data including a database 23. The memory 12 is used as a work area when the CPU 11 executes various processes. In the following description, the action of the controller 10 (and more specifically the CPU 11 of the controller 10) executing a program will also be simply referred to by the program name. For example, the description “the printing app 22” may also be used to signify “the CPU 11 executing the printing app 22.”

The CPU 11 may read the printing app 22 from a storage medium that is readable by the CPU 11. Storage media that the CPU 11 can read may include CD-ROM, DVD-ROM, and USB memory, for example.

The user interface 13 includes hardware that displays screens for reporting information to the user, and hardware that accepts user operations. The user interface 13 in this embodiment includes a combination of a display 13a capable of displaying information; and a mouse 13b and a keyboard 13c having input-receiving functions. As an alternative, the user interface 13 may be a touchscreen having a display function and an input-receiving function.

The communication interface 14 includes hardware for communicating with external devices, such as the label printer 3. The communication standard of the communication interface 14 may be Ethernet, Wi-Fi (U.S. trademark of Wi-Fi Alliance CORPORATION), or Universal Serial Bus (USB). The PC 1 may also include a plurality of communication interfaces 14 each supporting a corresponding communication standard.

The OS 21 stored in the memory 12 of the PC 1 may be iOS (U.S. trademark of Cisco Technology, Inc.), Android (U.S. trademark of Google LLC Limited), Windows (U.S. trademark of Microsoft Corporation), macOS (U.S. trademark of Apple Inc.), or Linux (U.S. trademark of Torvalds, Linus), for example.

The printing app 22 is a program with functions for controlling the PC 1 to accept instructions from the user via the user interface 13, and to edit an image to be printed and transmit printing instructions to the label printer 3 based on the received instructions. The printing app 22 is an example of the program.

The database 23 is a database having a table format defining rows and columns for storing a plurality of datasets. The database 23 is a user-generated file and is not stored in the memory 12 at the time the PC 1 is shipped from the factory. A plurality of databases 23 may be stored in the memory 12. The printing app 22 and database 23 will be described later in greater detail.

### Overall Configuration of the Label Printer 3

The label printer 3 in the embodiment has at least a printing function and a communication function. The label printer 3 includes a printer-side control panel 3a, a controller 3b, and a print engine 3c. The control panel 3a has operating parts that accept various operations, such as selections of data including print settings and templates, and instructions for executing a print operation. The control panel 3a may include a display for displaying data. The printing method employed by the label printer 3 is the thermal transfer method, the inkjet method, or the electrophotographic method, for example. When the label printer 3 receives via the communication function a print instruction and label data for a label to be printed from an external device such as the PC 1, the label printer 3 executes a print operation based on the label data to generate a label. The controller 3b has a configuration the same as the controller 10 and thus includes a CPU and a memory. The print engine 3b includes a print head to print an image on a label sheet to generate a label.

The label printer 3 can accommodate label paper in roll form, for example, and has functions for generating labels by printing images on this label paper using the print engine 3b. The roll of label paper is a wound roll of a printing medium including label paper overlaid on a continuous strip of release paper. The label paper may be a continuous strip of tape or may include die-cut labels that have been pre-cut into a predetermined shape. The label printer 3 of this embodiment may also have a function to cut and discharge the printed portion of the printing medium after printing is completed.

### Printing Procedure Using a Database

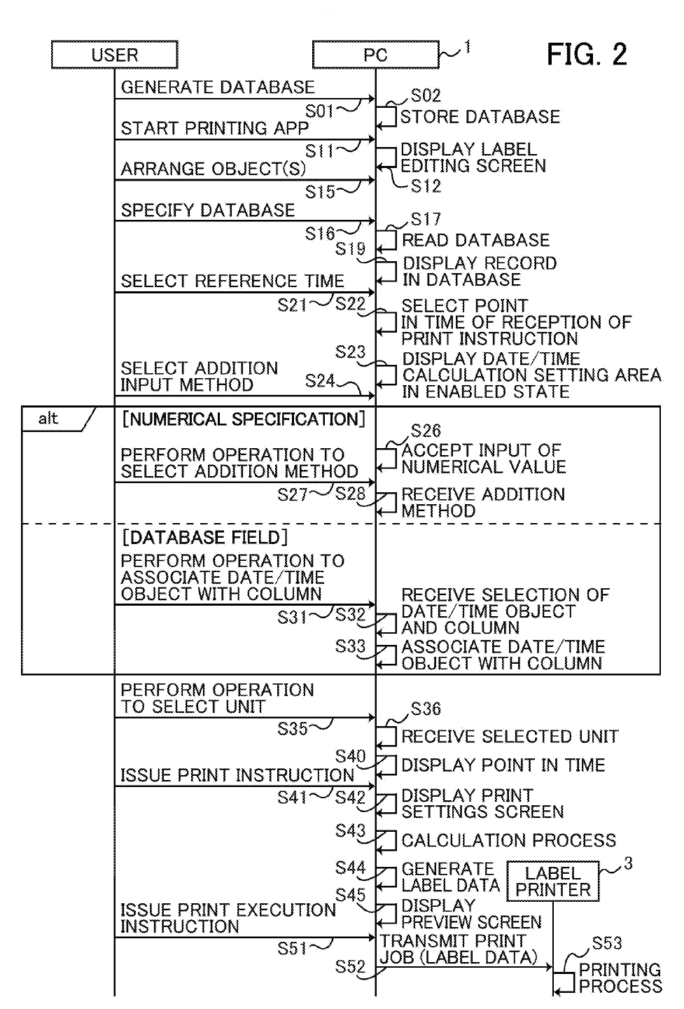

Next, a procedure for printing with a database will be described with reference to the sequence diagram in FIG. 2.

In the following description, actions such as “determine,” “set,” “obtain,” “receive,” represent processes performed by the CPU 11. Processes performed by the CPU 11 include processes that control hardware through an Application Programming Interface (API) of the OS 21. In this disclosure, each program will be described with details of the OS 21 being omitted. Note that the term “obtain” in this specification is used as a concept that does not necessarily require a request.

The printing app 22 of this embodiment can execute a database print based on a database file that includes text data. In the database print, the printing app 22 accepts a designation for a database to be used for printing and a designation for one or more text objects to be arranged in the label data, and instructions to associate the designated database with the text objects. A text object is an object that contains a character string.

In response to receiving an instruction to execute a database print, the printing app 22 generates a plurality of sets of label data by writing the set of text data contained in the designated database to the arranged text object. Here, each set of label data represents a label image to be printed on a label. The printing app 22 instructs the label printer 3 to print a plurality of labels based on the plurality of sets of generated label data. Here, the printing app 22 generates a set of label data in which each set of text data in the database is written in a text object in the order that text data is stored in the database and passes each set of generated label data to the label printer 3 so that the label printer 3 can generate a plurality of printed labels each displays a corresponding set of text data included in the database.

With a database print, the printing app 22 of the embodiment can also generate a set of label data in which a plurality of text objects are arranged. A database file includes a plurality of rows, each corresponding to a record, and a plurality of columns, each corresponding to a field defined for each row, for example. When a row is registered in the database file, text data is written to each column in that row. In response to receiving a specification for such a database file, the printing app 22 can associate one text object with each column defined in the database file. In this case, the printing app 22 generates a set of label data for each row of the database file by writing the set of text data from each column in that row into the text object associated with that column. By generating a set of label data sequentially for each row in the database file and passing this label data to the label printer 3, the printing app 22 can generate a plurality of labels in such a manner that a plurality of sets of text data printed is printed on each of the plurality of labels.

The printing app 22 of the embodiment can further generate a set of label data in which a plurality of date/time objects is arranged. A date/time object is an object specifying a value of a time (point in time) such as a date or a time of day. The data/time object may specify both the date and the time of the day. The printing app 22 can accept specifications of numerical values representing a point in time (a date or a time of day) to be written in the date/time object. When a print instruction is received, a point in time (a date or a time of day) at which the print instruction is issued is written to the date/time object, for example. The printing app 22 establishes a one-to-one correspondence between each column of the database and a date/time object and writes a point in time calculated based on data entry in the column of each row into the date/time object. Accordingly, the printing app 22 generates a plurality of sets of label data each having a different point in time. The set of label data may have a plurality of date/time objects each corresponds to a data entry in a corresponding column. The printing app 22 can generate a set of label data by writing a point in time calculated based on a printing point in time to the date/time object. The printing point in time may be a reference point in time (a reference date or reference time in day) for use to calculate the points in time to be printed on labels. The point in time an example of a time-related value or time related information.

The following description will first cover the procedure in which the printing app 22 instructs the PC 1 to calculate points in time (dates in this example) based on data entries in the database and to generate and print a plurality of sets of label data each having the calculated point in time written to the date/time objects.

### Database Creation Process

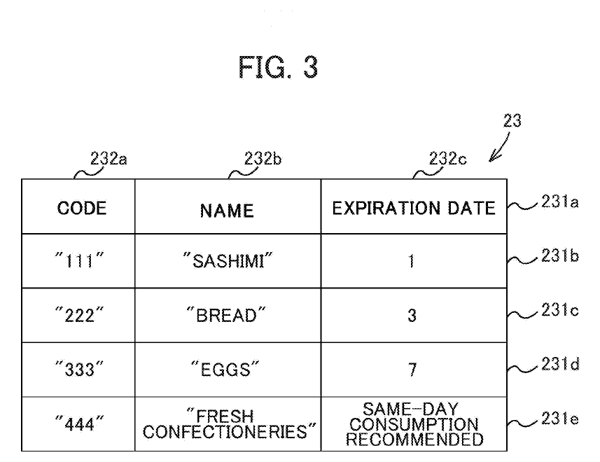

In S01 of the printing procedure shown in FIG. 2, a user who wishes to generate labels that contain points in time (dates or times of day), for example, generates a database 23 storing the data to be printed. In S02 the user instructs the PC 1 to store this database 23. FIG. 3 shows an example of a database 23 containing sets of text data that has been separated by commas and line breaks. Each set of text data has a character string to be printed on a label. The user generating the labels sets the character strings for the sets of text data and generates a database 23 that stores each character string as a set of text data.

The file that stores the database 23 may be a file in the comma-separated values (CSV) format or the Excel (U.S. trademark of Microsoft Corporation) format, for example. Hence, the database 23 in the embodiment is a relational database or similar type of database that arranges data in a table form. The user may generate the database 23 using an application program designed for generating tables or may generate the database 23 as a text file having a series of text strings as sets of data. The user may generate the database 23 on the PC 1 or may transfer a database 23 generated on another device to the PC 1 to be stored on the PC 1.

The database 23 shown in the example of FIG. 3 has a first row 231a that has titles of fields. That is, the first row 231 stores a set of text data representing a title for sets of text data contained in each column. Each of the second and subsequent rows 231b, 231c, 231d, and 231e in the database 23 stores text data sets for each of the products (sashimi, bread, eggs, and fresh confectioneries). In this example, the second and subsequent rows 231b, 231c, 231d, and 231e can be the print targets while the first row 231a is excluded from the print targets. The print targets may be all rows or may be specific rows selected from the database 23. The database 23 has columns 232a, 232b, and 232c that store sets of text data specifying a code, a name, and an expiration date, respectively, for each row. A set of text data for each of the code, the name, and the expiration date is inputted via the user interface 13. The code is a product code while the name is the product name.

### Label Editing Process

As shown in FIG. 2, after the database 23 has been stored in the memory 12, in S11 the printing app 22 is started up in response to a user operation on the user interface 13. In S12 the printing app 22 displays a label editing screen on the display 13a of the user interface 13. At this time, the PC 1 can accept operations in the label editing screen in accordance with user operations on the mouse 13b or the keyboard 13c of the user interface 13. The process of S12 is an example of the display process and an example of the displaying step.

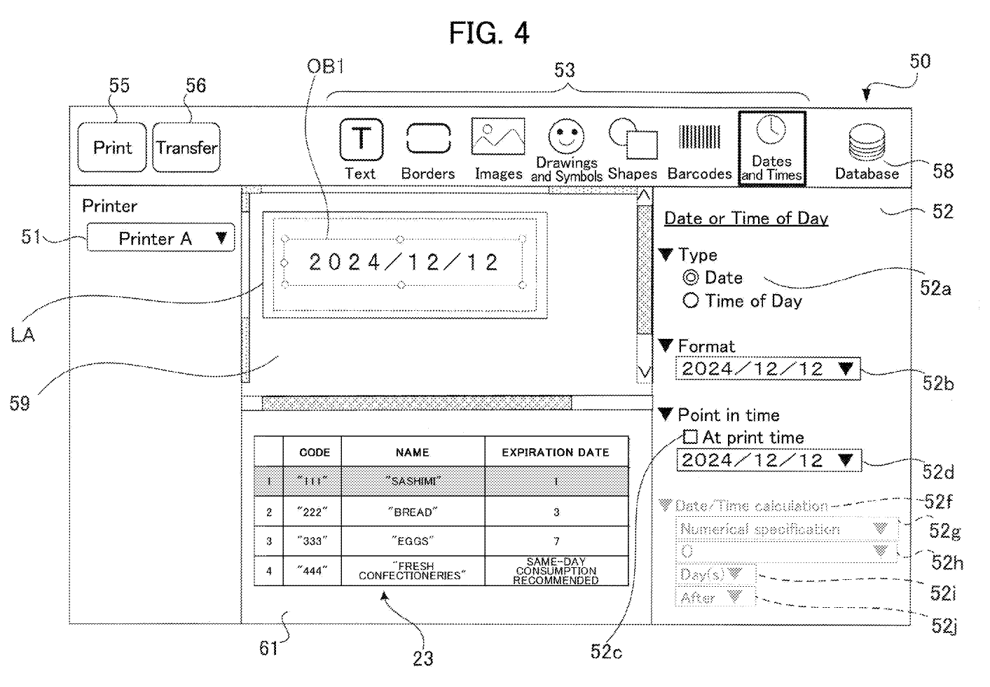

FIG. 4 shows an example of a label editing screen 50. The label editing screen 50 includes a printer selection field 51, a label display area 59, a database display area 61, and an object configuration area 52; and buttons that accept various instructions including a Print button 55, a Transfer button 56, a Database button 58, and an object selection button set 53. Through the printer selection field 51, the user can select a label printer for printing the labels. The label display area 59 is an area that displays a preview image of the label being printed. The Print button 55 accepts a print instruction. The Transfer button 56 accepts a transfer instruction to send template data (described later) to the label printer 3. The Database button 58 accepts an instruction to designate a file that stores the database to be used for printing from among the files stored on the PC 1. The label editing screen 50 is an example of the editing screen.

The database display area 61 is arranged below the label display area 59 and displays the contents of a database. The database display area 61 is displayed when the user operates the Database button 58 and specifies a database and is not displayed when no database has been specified, i.e., when the Database button 58 has not been operated.

In the label editing screen 50, the user operates the PC 1 to generate sets of label data for labels to be printed. That is, in S15 the user arranges objects for configuring a label in a label area LA of the label display area 59. The label area LA shows the label currently edited. The printing app 22 has a plurality of types of objects that can be arranged in the label display area 59, including text, borders, images, drawings and symbols, shapes, barcodes, and dates and times. A user wishing to include a time (point in time, such as a date or a time of day) on a label can arrange a date/time object in the label area LA by using the mouse 13b to operate a Date/Time object selection button within the object selection button set 53. Note that one or more objects may be arranged in the label area LA. When arranging a plurality of objects in the label area LA, the types of objects may be the same or different.

After the user has arranged at least one of a text object, date/time object, and barcode object in the label area LA, the printing app 22 displays the Database button 58 in an operable state on the label editing screen 50 and can accept an instruction for a database print.

In S16 of FIG. 2, the user specifies a database by operating the Database button 58. In this example, the user specifies the database 23. Specifically, when the user operates the Database button 58, the printing app 22 displays a list of the databases stored in the memory 12 in a selectable state and can accept the selection of a database via the user interface 13. Once the user specifies the database 23 shown in FIG. 3, for example, in S17 the printing app 22 reads the database 23 from the memory 12, and in S19 displays records in the database 23 in the database display area 61 in a tabular format, as illustrated in FIG. 4. The process of S16 is an example of the specifying process and an example of the specifying step.

As shown in FIG. 4, the object configuration area 52 is displayed to the right of the label display area 59 in the label editing screen 50. In the label display area 59, the user can select one of the objects arranged in the label area LA as an editing target. At this time, the object configuration area 52 displays settings for the object selected in the label display area 59 and can accept values for those settings. The content displayed in the object configuration area 52 changes according to the object selected in the label display area 59.

FIG. 4 shows an example in which a date/time object OB1 has been selected. When a date/time object is selected, the object configuration area 52 includes a type setting field 52a, a format setting field 52b, a Print Time checkbox 52c, a reference date/time setting field 52d, and a date/time calculation setting area 52f.

The type setting field 52a is used to set the type of content to be included in the date/time object. Types of content are the date (year / month / day) or the time of day (hour : minute : sec). The format setting field 52b is used to set the format of the content. The Print Time checkbox 52c enables the user to select whether the reference time for the point in time (the date or the time of day) to be included in the date/time object is set to be the point in time (the date or the time of day) at which the print instruction is received.

In S21 of FIG. 2, the printing app 22 selects the reference time for the point in time (the date or the time of day) to be included in the date/time object through the Print Time checkbox 52c displayed on the user interface 13. When a check has not be entered into the Print Time checkbox 52c via the user interface 13, as shown in FIG. 4, the printing app 22 selects the date or the time of day specified in the reference date/time setting field 52d as the reference time rather than the point in time (the date or the time of day) at which the print instruction is received. When a check is not present in the Print Time checkbox 52c, the date/time calculation setting area 52f is disabled. Hiding and graying out the date/time calculation setting area 52f are examples of methods for disabling the date/time calculation setting area 52f.

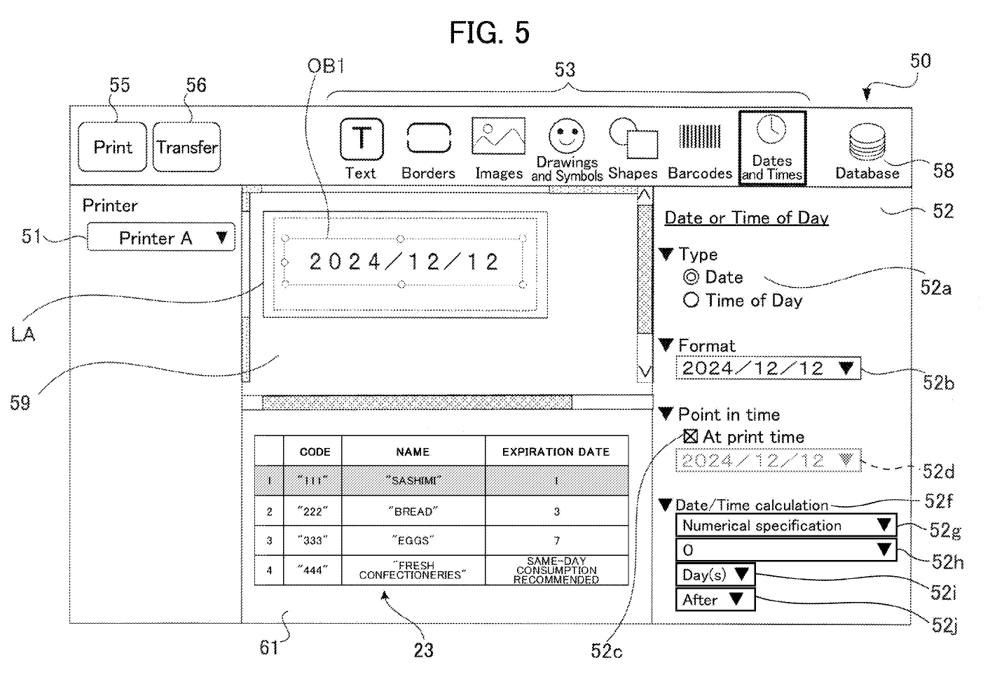

On the other hand, when a check is entered into the Print Time checkbox 52c using the user interface 13, in S22 the printing app 22 selects the point in time (the date or the time of day) at which the print instruction is received to be the reference time. When the point in time (the date or the time of day) at which the print instruction is received is selected as the reference time, in S23 the printing app 22 displays the date/time calculation setting area 52f on the user interface 13 in an enabled state, as shown in FIG. 5. The reference date/time setting field 52d is disabled when the point in time (the date or the time of day) at which the print instruction is received is selected as the reference time.

The date/time calculation setting area 52f accepts settings for items related to the date/time calculation. As shown in FIG. 5, the date/time calculation setting area 52f includes an addition input method selection field 52g, a numerical value input field 52h, a unit selection field 52i, and an addition method selection field 52j.

Through the addition input method selection field 52g, the user can select the method of inputting a numerical value to be used for calculating the point in time (the date or the time of day), i.e., the numerical value to be added (the addition time). The addition input method selection field 52g includes the options “Numerical specification,” “Database field,” and “No calculation.” The “Numerical specification” option uses a fixed value for the addition time. The “Database field” option uses data from a column of the database as the addition time. The “No calculation” option does not calculate any time.

In S24 of FIG. 2, the printing app 22 accepts a selection for the addition input method via the addition input method selection field 52g. When the user selects “Numerical specification” in the addition input method selection field 52g via the user interface 13, as shown in the example of FIG. 5 (alt: Numerical specification), the printing app 22 displays the numerical value input field 52h in the date/time calculation setting area 52f. In S26 of FIG. 2, the printing app 22 accepts input of a numerical value to be added through the numerical value input field 52h. The process of S24 is an example of the method selecting process. The process of S26 is an example of the numerical value receiving process. “Numerical specification” selectable for the addition input method selection field 52g is an example of the second option.

Further, when “Numerical specification” is selected in the addition input method selection field 52g, the printing app 22 displays the addition method selection field 52j in the date/time calculation setting area 52f in an enabled state. In S27 the user performs an operation on the addition method selection field 52j to select an addition method that defines a direction for adding the numerical value to the point in time (the date or the time of day) at which the print instruction is received, and in S28 the printing app 22 receives this selection.

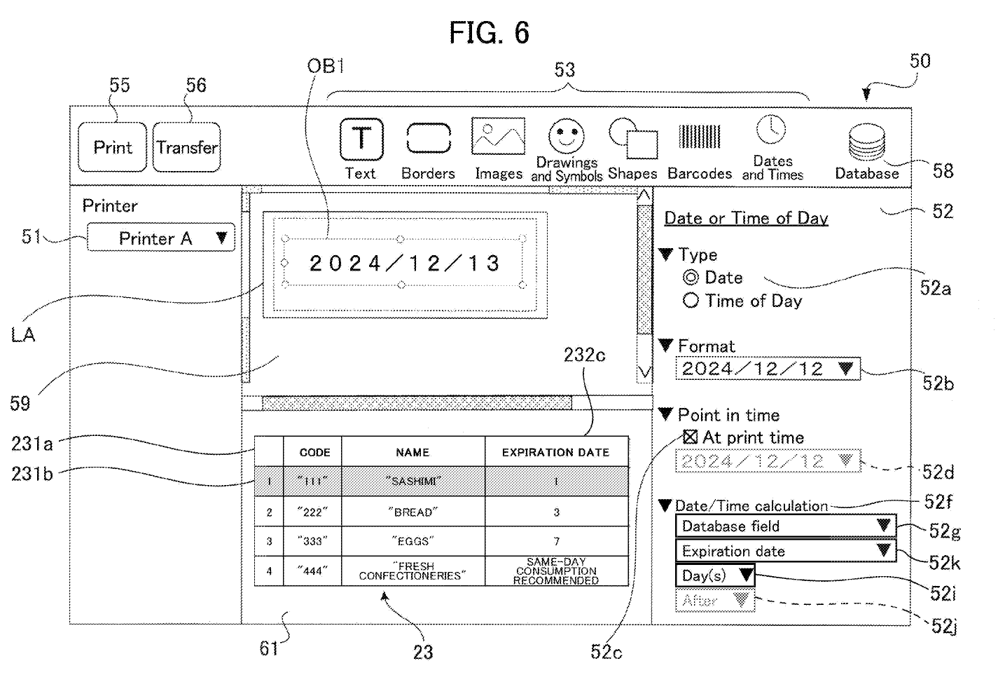

On the other hand, when the user selects “Database field” in the addition input method selection field 52g through the user interface 13, as shown in the example of FIG. 6 (alt: Database field), the printing app 22 displays a database field designation field 52k in the date/time calculation setting area 52f. The database field designation field 52k selectively displays the title of each column stored in the first row 231a of the database 23 currently displayed in the database display area 61. “Database field” selectable for the addition input method selection field 52g is an example of the first option.

In S31 of FIG. 2, the printing app 22 accepts a user operation to associate one date/time object arranged in the label display area 59 with one column of the designated database 23. Specifically, when the title “Expiration date” is selected from the database field designation field 52k via the user interface 13 while the date/time object OB1 is selected, in S32 the printing app 22 receives the selection of the date/time object OB1 and the selection of the column 232c, which corresponds to the title “Expiration date.” The process of S32 is an example of the object selecting process, an example of the object selecting step, an example of the column selecting process, and an example of the column selecting step.

In S33 the printing app 22 associates the selected date/time object OB1 with the selected column 232c.

In S35 the user selects the unit (time unit) for the date/time calculation through the unit selection field 52i displayed in the date/time calculation setting area 52f, and in S36 the printing app 22 receives this selection. Selectable units are week, day, hour, minute, and second, for example. Note that when the user selects “Database field” in the addition input method selection field 52g, the printing app 22 disables the addition method selection field 52j and does not accept a selection of an addition direction. The process of S36 is an example of the unit selecting process.

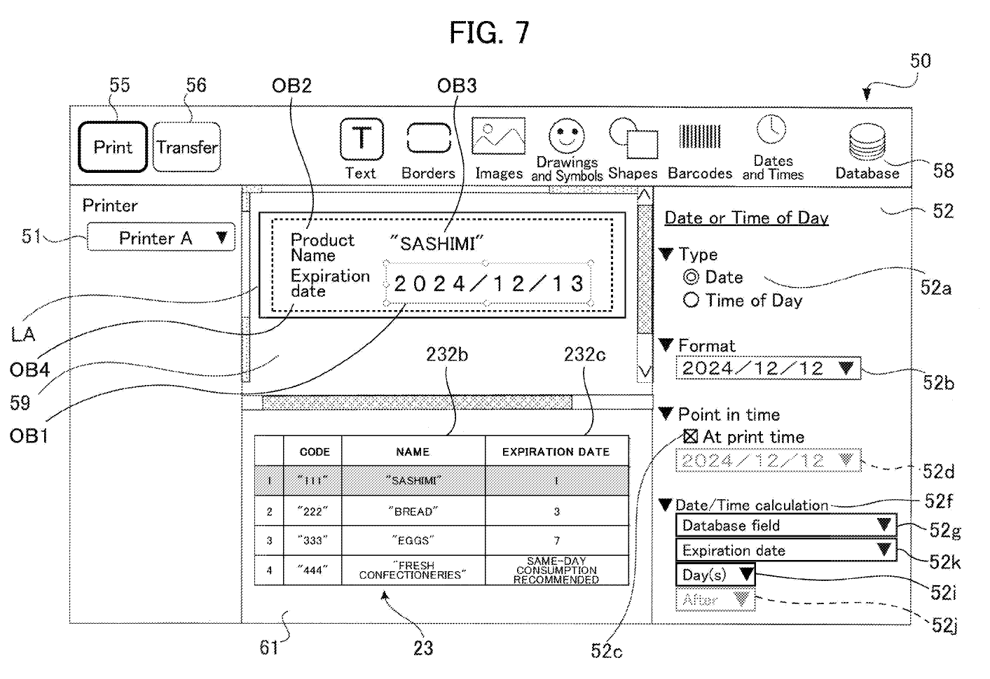

In S40 the printing app 22 displays the point in time (the date or the time of day) in the selected date/time object OB1 based on the settings in the object configuration area 52. In addition to the date/time object OB1, the user can arrange text objects OB2, OB3, and OB4 in the label area LA, as shown in the example of FIG. 7, and can edit the label with these text objects using the printing app 22. In this example, the column 232b representing “Name” in the designated database 23 is associated with the text object OB3.

To print the edited labels on the label printer 3, in S41 of FIG. 2 the user operates the Print button 55 in the label editing screen 50 using the user interface 13 to issue a print instruction. In response to receiving the print instruction, the printing app 22 may store template data in the memory 12 based on the edited label indicated at the time when the Print button 55 is operated. The template data includes information based on the edited label indicating a type of the label, a size of the label, settings set through the object configuration area 52, a layout of objects, and column information specifying columns in the database 23 associated with one or more of the arranged objects. The template data may be referred to simply as “template.” The series of processes S01-S41 may be referred to as a process for preparing and generating a template. In response to receiving the print instruction based on the operated Print button 55, in S42 the printing app 22 displays a print settings screen. In S43 the printing app 22 executes a calculation process to calculate a date/time based on data in the column selected in S32 for each row of the database 23 specified during the editing of the label for printing.

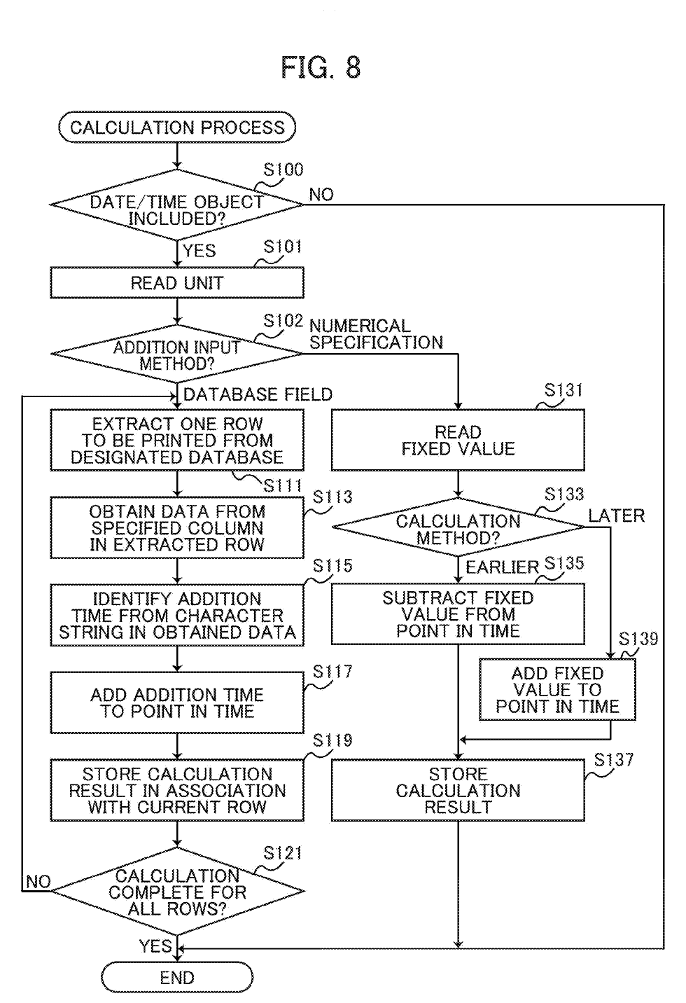

The calculation process will be described next with reference to FIG. 8. The CPU 11 of the PC 1 executes the calculation process shown in FIG. 8 according to the printing app 22. In S100 the CPU 11 determines whether any of the labels in the designated database include a date/time object involving execution of a date/time calculation. The CPU 11 determines that no date/time calculation is involved when none of the labels to be printed contain a date/time object or when any one of the labels to be printed contains a date/time object but the corresponding Print Time checkbox 52c is not checked and the reference time of the date/time object is the point in time (the date or the time of day) specified in the reference date/time setting field 52d. When the execution of a date/time calculation is not involved (S100: NO), the CPU 11 ends the calculation process.

However, when any of the labels includes a date/time object for which the printing app 22 has received a check in the Print Time checkbox 52c and a setting in the date/time calculation setting area 52f, the CPU 11 determines that one or more labels to be printed include a date/time object involving execution of a date/time calculation. When one or more labels includes a date/time object for which the execution of a date/time calculation is involved (S100: YES), in S101 the CPU 11 reads the unit (time unit) selected in the unit selection field 52i of the label editing screen 50. In this example, the user has selected “Days” in the unit selection field 52i.

After reading the unit in S101, in S102 the CPU 11 determines the addition input method. When the addition input method is “Numerical specification” (S102: Numerical specification), in S131 the CPU 11 reads the fixed value inputted into the numerical value input field 52h of the label editing screen 50. In S133 the CPU 11 checks the addition method selected in the addition method selection field 52j of the label editing screen 50.

When “Before” is selected in the addition method selection field 52j, the CPU 11 interprets the calculation direction as “earlier”. When the calculation method (calculation direction) is earlier (S133: Earlier), in S135 the CPU 11 subtracts the fixed value read in S131 from the corresponding point in time (date or the time or day) at which the print instruction is received according to the unit read in S101.

On the other hand, when “After” is selected in the addition method selection field 52j of the label editing screen 50, the CPU 11 interprets the calculation direction as “later.” When the calculation method is later (S133: Later), in S139 the CPU 11 adds the fixed value read in S131 to the corresponding point in time (date or time of day) at which the print instruction is received according to the unit read in S101. In S137 the CPU 11 stores the calculation result of S135 or S139 in the memory 12 and subsequently ends the calculation process.

Therefore, when the Print Time checkbox 52c is checked during the editing of the label for printing and the reference time for printing the date/time object is set to the point in time (the date or time of day) at which the print instruction is received, and the addition input method is “Numerical specification,” the printing app 22 stores one calculation result for all the labels to be printed in the memory 12.

On the other hand, when “Database field” is selected in the addition input method selection field 52g, the CPU 11 determines that the addition input method is to be a database field (S102: Database field).

When the addition input method is the database field, in S111 the CPU 11 extracts one row to be printed from the designated database. In S113 the CPU 11 obtains data from the column associated with the date/time object in the extracted row. Using the database 23 in FIG. 3 as an example, the CPU 11 obtains the character string “1” from column 232c in row 231b of the database 23.

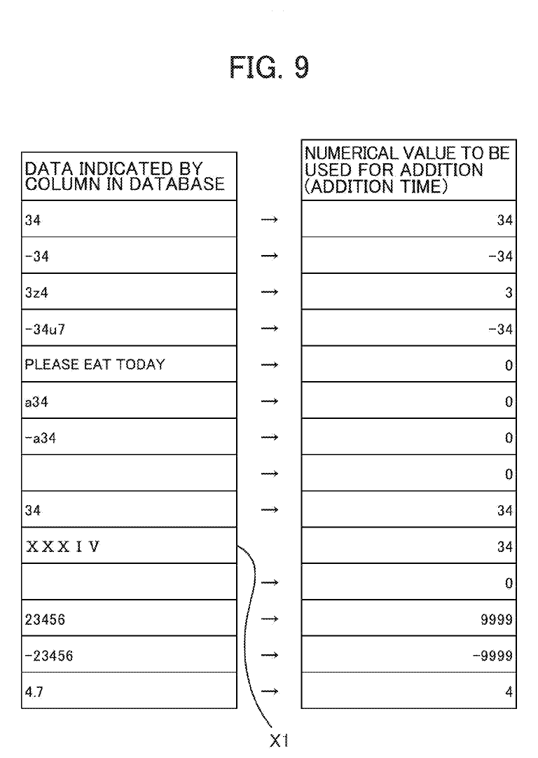

In S115 the CPU 11 identifies the addition time from the character string represented by the obtained data. The method of identifying integer values from the data in the database will be described with reference to FIG. 9. Each of the integer values identified is a signed integer value (explicitly signed positive integer such as “+34” or explicitly singed negative integer such as “-34”) or an unsigned integer value (such as “34”).

The printing app 22 analyzes the character string in the data obtained from the database 23 to determine whether characters beginning from the first character in this character string represent an integer value (a signed or unsigned integer value). When the printing app 22 finds that the character string includes a non-numeric character (or a non-digit character) following a detected integer part, the printing app 22 identifies the detected integer part as the addition time. That is, in this case, the detected integer part is a character string leading up to but not including the character found to be not part of an integer value. For example, the character string in the data obtained from the database 23 includes a numeric character and a character indicating a time unit immediately following the numeric character, such as “3days”, the printing app 22 can appropriately extract and identify the numeric character “3” from the character string “3days”.

In a case where the character string includes characters that represent an integer value (a signed or unsigned integer value) but does not include any other character, such as the data “34” and “-34” shown in the database column of FIG. 9, the printing app 22 identifies this character string as the numerical value to be added (the addition time). For example, the printing app 22 identifies the character string “34” shown in the database column of FIG. 9 as the addition time “34”. In other words, the printing app 22 reads an addition time “34” from the character string “34”. For example, the printing app 22 identifies the character string “-34” shown in the database column of FIG. 9 as the addition time “-34”. In other words, the printing app 22 reads an addition time “-34” from the character string “-34”.

For character strings having a character that is a non-numeric character (or a non-digit character) after characters that do represent an integer value (a signed or unsigned integer value), such as the data “3z4” and “-34u7” shown in the database column, the printing app 22 identifies the character string leading up to but not including a character that does not represent an integer value (numeric character or numeric digit) as the addition time. In these examples, the characters strings “3” and “-34” leading up to the respective characters “z” and “u” that do not represent numeric digits are identified as the addition time. For example, the printing app 22 identifies the character string “3z4” shown in the database column of FIG. 9 as the addition time “3” and ignoring “z4”. In other words, the printing app 22 reads (or extracts) an addition time “3” from the string “3z4”. For example, the printing app 22 identifies the numeric string “34u7” shown in the database column of FIG. 9 as the addition time “34” and ignoring “u7”. In other words, the printing app 22 reads (or extracts) an addition time “34” from the string “34u7”.

When the character string does not include any part representing an integer value (a signed or unsigned integer value), such as the data “PLEASE EAT TODAY” shown in the database column of FIG. 9, the printing app 22 determines the addition time to be “0” since no numerical value has been identified. That is, the printing app 22 identifies the character string “PLEASE EAT TODAY” shown in the database column of FIG. 9 as the addition time “0”. In other words, the printing app 22 reads the addition time “0” from the character string “PLEASE EAT TODAY”. That is, the printing app 22 interprets the character string “PLEASE EAT TODAY” as the addition time “0”.

The printing app 22 also identifies the addition time to be “0” when the leading character of the character string does not represent a part of an integer value (a signed or unsigned integer value), such as the data “a34” shown in a row in a column in the database. The printing app 22 also identifies the addition time to be “0” for a row in the column when the second character of the character string does not represent an integer value (a signed or unsigned integer value) even when the first (initial) character is a positive or negative sign, such as the data “-a34” shown in the database column. That is, the printing app 22 identifies the character string “a34” shown in the database column of FIG. 9 as the addition time “0”. In other words, the printing app 22 reads the addition time “0” from the character string “a34”. That is, the printing app 22 interprets the character string “a34” as the addition time “0”. The printing app 22 identifies the numeric string “-a34” shown in the database column of FIG. 9 as the addition time “0”. In other words, the printing app 22 reads the addition time “0” from the character string “-a34”. That is, the printing app 22 interprets the character string “-a34” as the addition time “0”.

When a row in the column in the database is blank, for example, the printing app 22 identifies the addition time to be “0” for that row in the column.

When the character string begins with a space before an integer value (a signed or unsigned integer value), as in the data “_34” (where “_” denotes a space) shown in the database column, the printing app 22 ignores the space. In this case, the printing app 22 identifies the addition time to be “34”. That is, the printing app 22 identifies the character string “_34” (where “_” denotes a space) shown in the database column of FIG. 9 as the addition time “34”. In other words, the printing app 22 reads (or extracts) the addition time “34” from the character string “_34” (where “_” denotes a space).

The printing app 22 converts a character string represented by a non- ASCII-character-based numeral into a corresponding ASCII-character based character string, in order to read an addition value from the converted ASCII-character based character string. For example, as indicated in X1 of FIG. 9, the printing app 22 converts the character string of a Roman numeral “XXXIV” into the ASCII-character based numeral “34” and identifies the converted character string as the addition time “34”. In other words, the printing app 22 reads the addition time “34” from the character string “XXXIV”. The printing app 22 also converts a non-ASCII-character including double-byte characters such as kanji (Chinese character) into a corresponding ASCII-character based character string to read an addition time from the converted character string.

The printing app 22 may also allow an upper limit and lower limit to be set for integer values (a signed or unsigned integer values). For example, when the upper limit for integer values (signed or unsigned integer values) has been set to “9999”, the printing app 22 identifies the addition time to be the upper limit “9999” when the character string represented by the data in the database column is value that exceeds that upper limit, such as the character string “23456”. Similarly, when the lower limit for integer values (signed or unsigned integer values) is set to “-9999”, the printing app 22 identifies the addition time to be the lower limit “-9999” when the character string represented by the data in the database column is less than this lower limit, such as the character string “-23456”. As an alternative, when the numerical value specified in the database column exceeds the upper limit or is less than the lower limit, the printing app 22 may identify the addition time to be “0” or another numerical value within the range of numerical values that the printing app 22 can recognize.

The printing app 22 may set a requirement for rounding down fractions. For example, when the data in the database column is a character string containing a fraction as in “4.7”, the printing app 22 identifies the addition time to be “4”.

These methods of identification are examples and are not limited to these. For example, the character string in the specified column 232c may include the unit of addition time (weeks, days, hours, minutes, or seconds) and the calculation direction (before or after), as in “10 days” or “10 days after”. When unit of addition time or the calculation direction is included in the character string of the specified column 232c, the unit selection field 52i and addition method selection field 52j may be disabled and the printing app 22 may not execute S35 and S36 of FIG. 2. By disabling the unit selection field 52i and addition method selection field 52j, the printing app 22 uses the unit of addition time (weeks, days, hours, minutes, or seconds) and the calculation direction (before or after) based on a sing of the numeral indicated by data in the database 23, thereby generating labels reflecting the intension of the user who generates the database 23. The addition method selection field 52j may be solely disabled since the calculation direction can be determined by a sign of the numeral identified by data in the specified column 232c. However, allowing the user to select the unit of addition time by displaying the unit selection field 52i and addition method selection field 52j on the user interface 13 enhances freedom in specifying numerical values that can be written to the column 232c of the database 23.

Returning to FIG. 8, after the CPU 11 has identified the addition time, in S117 the CPU 11 adds the addition time identified in S115 according to the unit read in S101 to the point in time at which the Print button 55 is operated, i.e., the point in time at which the print instruction is received. For example, when the CPU 11 extracts the second row 231b from the specified database 23 and obtains the value “1” stored in column 232c of the extracted row 231b, the CPU 11 identifies the addition time to be “1”. When the Print button 55 is operated at “2024/12/12” and the unit is to “Day(s)” in the unit selection field 52i, the CPU 11 calculates “2024/12/13”, which is ”2024/12/12” plus 1 day, as the point in time (the data in this case) to be included in the date/time object OB1.

When the addition time identified based on the data in column 232c is a negative number, the CPU 11 adds this negative number to a point in time at which the print instruction is received. In other words, the resultant value indicates a point in time that precedes the point in time at which the print instruction is received by the absolute value of the negative number. In effect, the absolute value of the negative number is subtracted from the point in time at which the print instruction is received. When the numerical value indicated by the data in column 232c is a positive number, the CPU 11 adds the absolute value of this numerical value to the point in time at which the print instruction is received. In other words, the resultant value indicates a point in time that follows the point in time at which the print instruction is received by the positive number (= the absolute value of the positive number).

In S119 the CPU 11 stores the calculation result such as “2024/12/13” in the memory 12 in association with the row 231b extracted in S111. In S121 the CPU 11 determines whether all date/time calculations have been completed. When a date/time calculation has not been performed for any of rows 231c, 231d, and 231e, the CPU 11 determines that date/time calculations have not been completed. When date/time calculations have not been completed for all rows to be printed (S121: NO), the CPU 11 returns to S111 and performs a date/time calculation for the next row. By repeating steps S111-S119, the CPU 11 calculates a point in time for each of the rows 231c, 231d, and 231e based on the data stored in column 232c of the corresponding row.

Specifically, the CPU 11 sets “3 days” based on both the unit “Day(s)” selected in the unit selection field 52i and the numerical value “3” stored in column 232c of row 231c. In this case, by adding, in the positive direction, the addition time of “3 days” to the date/time “2024/12/12” at which the print instruction is received (or issued), the CPU 11 calculates the date/time “2024/12/15” and stores this point in time in association with row 231c. Similarly, the CPU 11 sets “7 days” based on both the numerical value “7” stored in column 232c of row 231d and the unit “Day(s)” selected in the unit selection field 52i. In this case, adding, in the positive direction, the addition time to the date/time “2024/12/12” at which the print instruction is received, the CPU 11 calculates a date/time “2024/12/19” and stores this point in time in association with the row 231d. Further, the CPU 11 sets the addition time to “0 days” based on the value “PLEASE EAT TODAY” stored in column 232c of row 231e and the unit “Day(s)” selected in the unit selection field 52i. In this case, the CPU 11 stores the point in time “2024/12/12” at which the print instruction is received in association with row 231e calculated based on the addition time of “0 days” (in effect, setting the point in time to the date time at which the print instruction is issued without performing any calculation).

After completing the date/time calculation for all rows to be printed (S121: YES), the CPU 11 ends the calculation process in FIG. 8. Hence, when the addition input method is a database field while the Print Time checkbox 52c is checked during the editing of the label and the reference time for the point in time for use to print the date/time object is set to the point in time at which the print instruction is received, the CPU 11 calculates different points in time for rows 231b, 231c, 231d, and 231e according to data in the specified column and stores these the points in time in the memory 12.

After executing the calculation process in S43 of FIG. 2, in S44 the printing app 22 generates sets of label data. In a database print, the printing app 22 generates a set of label data for each of the rows 231b, 231c, 231d, and 231e in the database 23 such that the calculation result associated with each row is written in the date/time object OB1 of the corresponding set of label data. Further, the printing app 22 generates a set of label data for each of the rows 231b, 231c, 231d, and 231e in the database 23 such that the data in the “Name” column 232b of the database 23 for each row is written in the text object OB3 (FIG. 7) of the corresponding set of label data. After generating label data for each row, in S45 the printing app 22 displays a preview screen in the print settings screen based on the generated sets of label data. The process of S44 is an example of the generating process and an example of a generating step. The process of S45 is an example of the preview process.

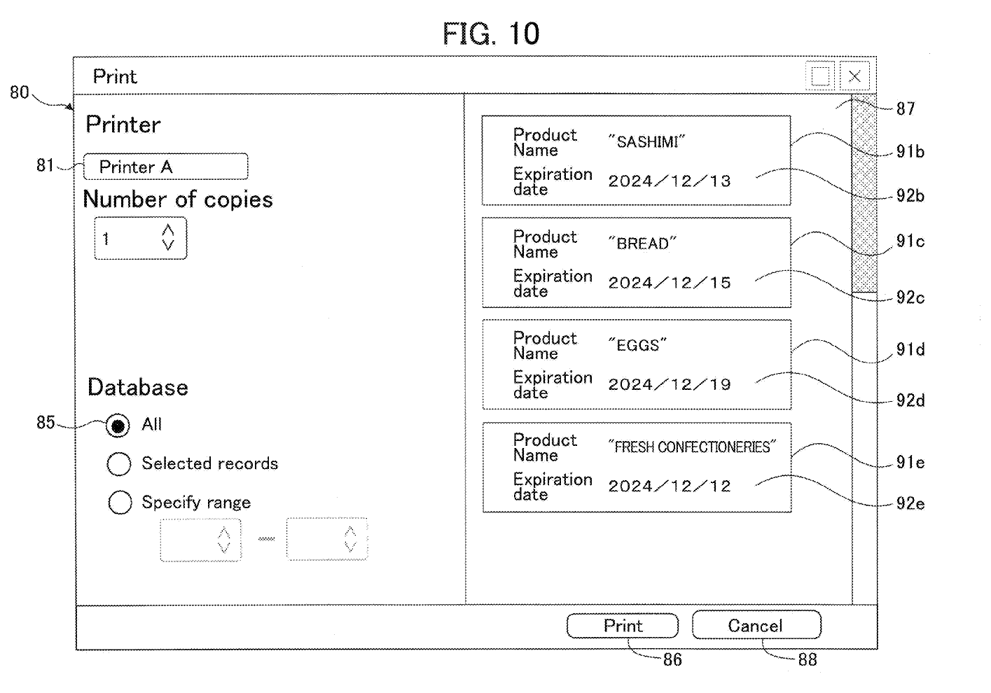

FIG. 10 shows a print settings screen 80 that includes a printer setting field 81, a database print setting field 85, a preview display area 87, a Print button 86, and a Cancel button 88. The printer setting field 81 accepts a specification for a printer to execute the print. The database print setting field 85 is displayed when a database is being used to print the labels. The database print setting field 85 can accept a specification indicating what rows in the designated database are to be printed. When the user selects “All” in the database print setting field 85, the printing app 22 sets all rows recorded in the designated database as print targets. When the user selects “Selected records” or “Specify range” in the database print setting field 85, the printing app 22 sets the selected rows as the print targets.

The preview display area 87 displays preview images of the sets of label data to be printed on the selected label printer 3. The preview images are displayed in the preview display area 87 based on the label data generated in S44, for example. FIG. 10 shows a sample display when all rows are to be printed. In this example, points in time 92b, 92c, 92d, and 92e calculated based on data in column 232c for each row 231b, 231c, 231d, and 231e are displayed in preview images 91b, 91c, 91d, and 91e. Accordingly, the points in time 92b, 92c, 92d, and 92e are different for each set of label data. To execute a print, the user operates the Print button 86 using the user interface 13. When the user determines not to print, the user operates the Cancel button 88. In the preview display area 87, preview images for all the records (rows) may be displayed. Alternatively, preview images corresponding to records (rows) selected as print targets in the database print setting field 85 may be displayed but preview images corresponding to records other than the print targets may not be displayed. The print settings screen 80 is an example of the preview screen.

As shown in FIG. 2, when the printing app 22 receives a print execution instruction to execute a print in S51 through an operation on the Print button 86, in S52 the printing app 22 transmits, to the label printer 3, a print job containing the sets of generated label data corresponding to records (rows) selected as print targets through the database print setting field 85 (FIG. 10). In response to the print job received, in S53 the label printer 3 can print the sets of label data included in the print job as is to generate labels on which corresponding points in times are represented. The process of S52 is an example of the printing process and an example of the printing step.

### Transfer Print

Next, a process to perform a transfer print will be described. In this process, the printing app 22 transfers the template data and a database to the label printer 3. The label printer 3 calculates a point in time (a date or a time of day) based on the template file and database received from the printing app 22, generates label data in which the calculated date/time is written, and perform printing based on this label data.

Here, the printing app 22 generates a database and a template to be transferred to the label printer 3. When the Transfer button 56 is operated in the label editing screen50 shown in FIG. 7 subsequent to the procedures the same as the processes of S01-S40, the printing app 22 stores in the memory 12 a database and template data based on data received through the processes of S01-S40. Since the procedure to generate the database and the template is identical to that in S01-S40 of FIG. 2, a description of this procedure has been omitted here.

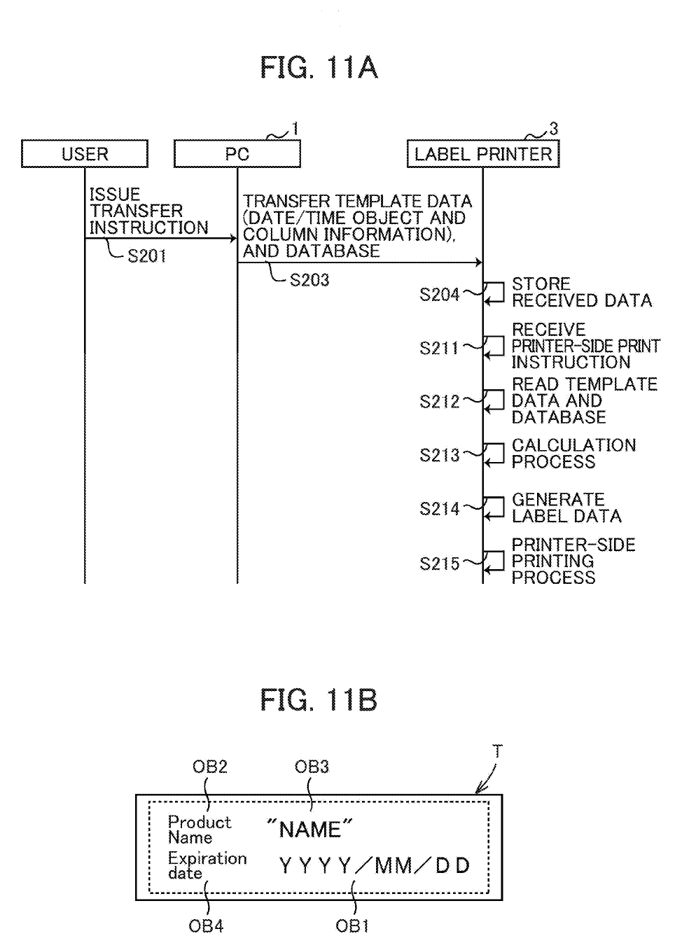

FIG. 11A shows a sequence diagram for a transfer print. As shown in FIG. 11A, to transmit a template that the user has generated to the label printer 3 after the procedures the same as that in S01-S40, the user operates the Transfer button 56 in the label editing screen 50 shown in FIG. 7, for example. In S201 of FIG. 11A, the printing app 22 receives a transfer instruction in response to a user operation on the Transfer button 56. Upon receiving the instruction, the printing app 22 generates template data and stores the template data in the memory 12. In S203 the printing app 22 transfers, to the label printer 3, the template data and the designated database. Here, the template data includes the date/time object selected in the label editing screen 50, column information specifying the selected column, and information on the settings set through the object configuration area 52. The process of S203 is an example of the transferring process and an example of the transferring step.

FIG. 11B shows an example of a template (template data) T in which the date/time object OB1 and text objects OB2, OB3, and OB4 are arranged. The printing app 22 transfers template data for this template T to the label printer 3. The template data T also includes column information specifying column 232c, which has been specified by the user when editing the date/time object OB1. The printing app 22 also transfers the database 23 designated by the user when editing the date/time object OB1 to the label printer 3. Here, sample data “YYYY/MM/DD” and “NAME” are written in the respective date/time object OB1 and text object OB3 included in the template data rather than text data from the specified columns 232c and 232b.

In response to receiving the template data and the database 23, in S204 the label printer 3 saves the template data and the database 23 in a storage area accessible by the label printer 3. The save location may be internal memory of the label printer 3 or an external device such as a server.

In this example, in S211 the controller 3b of the label printer 3 receives a printer-side print instruction to execute a print through the printer-side control panel 3a while the template T is selected. Here, the printer-side print instruction is issued within the label printer 3. When receiving the printer-side print instruction, in S212 the controller 3b reads the template data and the database 23 from the save location. The process of S212 is an example of the reading step.

In S213 the controller 3b executes a calculation process based on the data registered in each row 231b, 231c, 231d, and 231e of the database 23 to calculate a point in time to be written in the date/time object OB1. The calculation process of S13 is identical to the calculation process shown in FIG. 8, which is executed in S43 of FIG. 2, except that the reference time is a point in time (a date or a time of day) when printer-side print instruction in S211, and hence a description of this process is omitted here. The process of S213 is an example of the printer-side calculation process, and an example of the printer-side calculating step.

In S214 the controller 3b writes the data in the database 23 into the text object OB3 and the date/time object OB1 of the template T to generate a set of label data. For example, the label printer 3 generates sets of label data by writing the calculation results calculated in S213 to the date/time object OB1 of the template T for each row 231b, 231c, 231d, and 231e of the database 23. Since the procedure for generating the sets of label data in S214 is identical to that in S44 of FIG. 2, a description of this procedure has been omitted here.

After generating a set of label data for each row 231b, 231c, 231d, and 231e recorded in the database 23, in S215 the controller 3b performs printing based on the sets of generated label data. In other words, the label printer 3 generates and prints the sets of label data having the points in time calculated by the label printer 3 itself written in the date/time objects. In S215, the controller 3b may perform printing for all the generated sets of label data. Alternatively, in S215, the controller 3b may perform printing for a part of all the generated sets of label data. For example, the controller 3b may transmit data for representing a print settings screen the same as the print settings screen 80 shown in FIG. 10 to the PC 1 and receive information indicating which sets of label data have been granted print permission from the PC 1, and perform printing for the sets of label data for which the permission has been granted. The process of S215 is a label generating process and an example of the label generating step.

As described above in detail, the PC 1 that executes the printing app 22 in the embodiment selects one date/time object OB1 arranged in the label editing screen 50, designates the database 23, and selects one column 232c from the designated database 23. In response to a print instruction, the PC 1 calculates the point in time based on data in the selected column 232c for each row 231b, 231c, 231d, and 231e of the designated database 23 in accordance with the printing app 22. The PC 1 also executes a printing process according to the printing app 22 to generate and print the sets of label data having the calculated points in time written to the selected date/time objects OB1. In other words, the printing app 22 of the embodiment calculates the point in time based on data in the selected column 232c for each row 231b, 231c, 231d, and 231e of the database 23. Thus, by using data in a user selected column 232c to calculate the point in time to be specified in the date/time object OB1 when performing a printing process based on each row 231b, 231c, 231d, and 231e, the PC 1 can calculate and print different points in time for each of the rows 231b, 231c, 231d, and 231e of a single database 23 without having to use a separate database for each numerical value (addition time) being added to the point in time at which the print instruction is received.

When the printing app 22 receives a setting to use the point in time at which the print instruction is received as the reference time for calculating a point in time, the printing app 22 calculates the point in time to be printed on each label by referencing the point in time at which the print instruction is received. In this way, the printing app 22 can calculate the point in time to be printed based on the same reference time when printing a large number of labels, for example.

In the printing system 100 of the embodiment, based on the user operation, the PC 1 selects one date/time object arranged in the label editing screen, designates the database 23, and selects one column in the designated database in accordance with the printing app 22. In response to the transfer instruction, the PC 1 executes the transfer process to transfer the template data for a template T including the date/time object OB1 and column information, and the database 23 designated when generating the template (or when editing the label) to the label printer 3. The label printer 3 saves the template data and database. When a printer-side print instruction is received, the label printer 3 reads the saved template data and database and calculates a point in time based on data in the selected column 232c for each row 231b, 231c, 231d, and 231e in the database 23. The label printer 3 executes a printer-side printing process to generate and print a set of label data having the calculated point in time written to the date/time object OB1 included in the template data for each of the rows 231b, 231c, 231d, and 231e in the database 23. Thus, by calculating a point in time to be specified in the date/time object OB1 through a printer-side printing process for each row 231b, 231c, 231d, and 231e in the database 23 based on data in a user selected column 232c, the PC 1 can use a single database 23 to print different points in time calculated for each row 231b, 231c, 231d, and 231e without using different databases for different numerical values (addition times) to be added to the point in time at which the printer-side print instruction is received.

In the printing system 100 of the present embodiment, when the printing app 22 installed on the PC 1 receives a setting to use the point in time at which a print instruction is received as the reference for calculating a point in time to be printed on a label, the label printer 3 calculates the point in time to be printed on each label based on the point in time at which the printer-side print instruction is received. Accordingly, the label printer 3 can calculate points in time to be printed on labels based on the same reference time when printing a large quantity of labels.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are outlined below:

The printing medium used in the label printer is not limited to a roll of label paper but may also be fanfold paper or cut-sheet label paper.

The format or style of the display screens illustrated in the accompanying drawings is not limited to the examples in the drawings and can be modified. For example, the arrangement and shapes of the buttons are not limited to the examples in the drawings. Labels may also include graphics in addition to text and points in time.

Further, the database print setting field 85 may be omitted from the print settings screen 80 shown in FIG. 10, and thus the printing app 22 may not accept specifications of the print targets. However, the printing app 22 is more user-friendly when the user can specify rows in the database 23 to be printed.

The printing app 22 may not allow negative numbers to be set as data in the column 232c selected in the database field designation field 52k. In this case, the printing app 22 may enable the addition method selection field 52j when “Database field” is selected in the addition input method selection field 52g, and determine the addition direction for adding a numerical value to the point of time at which the print instruction is received based on the value selected in the addition method selection field 52j.

When the character string indicated by data in a column includes a character that do not represent a part of an integer (a signed or unsigned integer value), in S115 of FIG. 8 the CPU 11 may simply set the addition time to “0” and thus may not determine an addition time from the characters leading up to but not including the character found to be not a numeric character (numeric-digit). However, configuring the printing app 22 to estimate the addition time from an integer value represented by characters from the first character to a midpoint character of the character string improves flexibility in the values that can be written to the database 23.

When the data in column 232c contains a space, the printing app 22 may use the integer value before the space as the addition time. When column 232c is blank, for example, the printing app 22 may identify a numerical value other than “0” as the addition time. However, in a case where the printing app 22 treats the numerical value represented by data in column 232c as “0” when a row in the column 232c is blank and the numerical value cannot be determined from that row in the column 232c, any addition of time can be essentially disabled. Further, by treating a blank as “0”, the printing app 22 can set rows in the database for which no addition is performed, i.e., rows for which the point in time at which the print instruction is received with no change is printed on a label.

When the numerical value represented by data in column 232c exceeds the upper limit of addition time or is less than the lower limit, the printing app 22 may not calculate a point in time based on the upper or lower limit. However, the printing app 22 can avoid printing inappropriate times by treating the upper limit as the addition time when the numerical value exceeds the upper limit and treating the lower limit as the addition time when the numerical value is less than the lower limit.

When the reference for calculating the point in time is set to the point in time at which the print instruction is received, the selecting of “Numerical specification” as the addition input method may be disabled. However, by performing calculations with fixed values as a second option (numerical specification) in addition to the first option of using the database 23 (database field) as addition input methods, the printing app 22 improves flexibility with respect to what points in time can be written in the date/time objects. In other words, the printing app 22 can set a point in time to be printed on each label to a different point in time depending on the data in the column 232c in a case where the first option is selected and can set the point in time to be printed on each label to the same point in time in a case where the second option is selected.

The numerical value input field 52h and the database field designation field 52k may be displayed continuously when a date/time object is selected, and may not be enabled or disabled based on the selection in the addition input method selection field 52g. However, the printing app 22 limits the input of fixed values when “Database field” is selected in the addition input method selection field 52g by displaying the database field designation field 52k and not the numerical value input field 52h. On the other hand, when “Numerical specification” is selected in the addition input method selection field 52g, the printing app 22 disables specifying a column by displaying the numerical value input field 52h and not displaying the database field designation field 52k, thereby avoiding selecting or specifying of items that will not be used to reduce the user’s time and effort.

The printing app 22 may not display the preview images 91b, 91c, 91d, and 91e for the sets of label data having calculation results written to the date/time object OB1 for each row when a print instruction is received. However, by displaying a print image of a set of label data on the user interface 13 for each row 231b, 231c, 231d, and 231e in the database 23 and reflecting the calculation result in that print image, the printing app 22 can facilitate the user in confirming whether appropriate points in time are written in the label data.

In any of the flowcharts disclosed in the embodiment, the plurality of processes that make up any of a plurality of steps may be executed in parallel, or the order in which the processes are performed may be modified in any way that does not generate any inconsistencies in the processes.

The processes disclosed in the embodiment may be executed by a single CPU, a plurality of CPUs, an application specific integrated circuit (ASIC) or other hardware, or a combination of these components. Further, the processes disclosed in the embodiment may be achieved through a storage medium that stores the programs used to implement those processes or according to any of various other methods or formats.

The term “processor” encompasses both a single processor or a group of multiple processors located either locally or remotely working together or in a distributed fashion to collectively perform the tasks attributed to the “processor” described in this disclosure. One or more processors may be referred to as a controller.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A non-transitory computer-readable storage medium storing instructions for an information processing device,
the instructions, when executed in the information processing device, causing the information processing device to perform:
a display process including:
displaying an editing screen on a display in the information processing device, the editing screen being for receiving an operation to edit a reference label image;
an object selecting process including:
selecting a time-display object based on an operation received through the editing screen;
a specifying process including:
specifying a database defining rows and columns;
a column selecting process including:
selecting a column of the columns;
a calculating process in response to receiving a print instruction, the calculating process including:
calculating a time-related value for each of target rows based on data in the selected column of the each of the target rows, the time-related value indicating a date or a time of day, the target rows being two or more of the rows;
a generating process including:
generating a set of label data for each of the target rows based on the reference label image, the set of label data for the each of the target rows representing a label image in which the selected time-display object is placed and the time-related value for the each of the target rows is inserted into the time-display object; and
a printing process including:
instructing a label printer to print the label image based on the set of label data for each of one or more of the target rows.

2. The non-transitory computer-readable storage medium according to claim 1,
wherein in the calculating process, the time-related value for the each of the target rows is obtained by adding an addition value for the each of the target rows to a reference time-related value, the addition value for the each of the target rows being based on the data in the selected column of the each of the target rows, the reference time-related value indicating a reception date of the print instruction or a reception time of day of the print instruction.

3. The non-transitory computer-readable storage medium according to claim 1,
wherein the instructions, when executed in the information processing device, cause the information processing device to further perform:
a unit selection process including:
selecting a time unit,
wherein in the calculating process, the time-related value for the each of the target rows is obtained by adding an addition value for the each of the target rows to
a reference time-related value based on the time unit, the addition value for the each of the target rows being based on the data in the selected column of the
each of the target rows, the reference time-related value indicating a reception date of the print instruction or a reception time of day of the print instruction.

4. The non-transitory computer-readable storage medium according to claim 1,
wherein in the calculating process, when the data in the selected column of the each of the target rows indicates a positive value, the time-related value for the each of the target rows is obtained by adding the positive value to a reference time-related value, the reference time-related value indicating a reception date of the print instruction or a reception time of day of the print instruction,
wherein in the calculating process, when the data in the selected column of the each of the target rows indicates a negative value, the time-related value for the each of the target rows is obtained by subtracting an absolute value of the negative value from the reference time-related value.

5. The non-transitory computer-readable storage medium according to claim 2,
wherein the calculating process further includes:
setting, when a character string indicated by the data in the selected column of the each of the target rows includes a partial character string that represents a
signed or unsigned integer value and a non-digit character immediately following the partial character string, the addition value for the each of the target rows to
the signed or unsigned integer value, the partial character string beginning from an initial character of the character string.

6. The non-transitory computer-readable storage medium according to claim 2,
wherein the calculating process further includes:
setting, when the data in the selected column of the each of the target rows is blank, the addition value for the each of the target rows to zero.

7. The non-transitory computer-readable storage medium according to claim 2,
wherein the calculating process further includes:
setting, when the data in the selected column of the each of the target rows indicates a value exceeding an upper limit, the addition value to the upper limit.

8. The non-transitory computer-readable storage medium according to claim 1,
wherein the instructions, when executed in the information processing device, cause the information processing device to further perform:
a method selecting process including:
selecting an option from a plurality of options including a first option and a second option; and
a numerical value receiving process when the second option is selected, the numerical value receiving process including:
receiving a fixed numerical value;
a second calculating process in response to receiving the print instruction after the numerical value receiving process is completed, the second calculating process including:
calculating a common time-related value by adding the fixed numerical value to a reference time-related value, the reference time-related value indicating a reception date of the print instruction or a reception time of day of the print instruction;
a second generating process after the second calculating process is completed, the second generating process including:
generating a set of second label data for each of the target rows, the set of second label data for the each of the target rows representing a second label image in which the selected time-display object is placed and the common time-related value is inserted into the time-display object; and
a second printing process after the second generating process is completed, the second printing process including:
instructing the label printer to print the second label image based on the set of second label data for each of one or more of the target rows,
wherein when the first option is selected, the calculating process, the generating process, and the printing process are performed.

9. The non-transitory computer-readable storage medium according to claim 8,
wherein when the first option is selected, the numerical value receiving process is not performed,
wherein when the second option is selected, the column selecting process is not performed.

10. The non-transitory computer-readable storage medium according to claim 1,
wherein the instructions, when executed in the information processing device, cause the information processing device to further perform:
a preview display process prior to the printing process and in response to receiving the print instruction, the preview display process including:
displaying a preview image based on the set of label data for each of the target rows.

11. A printing system comprising:
an information processing device including:
a first controller including one or more first processors; and
a display; and
a label printer including:
a second controller including one or more second processors,
wherein the first controller is configured to perform:
a display process including:
displaying an editing screen on the display, the editing screen being for receiving an operation to edit a reference label image;
an object selecting process including:
selecting a time-display object based on an operation received through the editing screen;
a specifying process including:
specifying a database defining rows and columns;
a column selecting process including:
selecting a column of the columns;
a template generating process including:
generating template data, the template data including image data and column-identification data, the image data representing the reference label image in which the selected time-display object is placed, the column-identification data identifying the selected column; and
a transferring process in response to receiving a transferring instruction, the transferring process including:
transferring the template data and the database to the label printer,
wherein the second controller is configured to perform:
a storing process including:
storing the template data and the database both received from the information processing device in a storage;
a calculating process in response to receiving a printer-side print instruction issued within the label printer, the calculating process including:
reading both the template data and the database from the storage;
identifying the selected column based on the column-identification data;
calculating a time-related value for each of target rows based on data in the selected column of the each of target rows, the time-related value indicating a date or a time of day, the target rows being two or more of the rows;
a generating process including:
generating a set of label data for each of the target rows, the set of label data for the each of the target rows representing a label image in which the selected time-display object is placed and the time-related value for the each of the target rows is inserted into the time-display object; and
a printing process including:
printing the label image based on the set of label data for each of one or more of the target rows.

12. The printing system according to claim 11,
wherein in the calculating process, the time-related value for the each of the target rows is obtained by adding an addition value for the each of the target rows to a reference time-related value, the addition value for the each of the target rows being based on the data in the selected column of the each of the target rows, the reference time-related value indicating a reception date of the printer-side print instruction or a reception time of day of the printer-side print instruction.
